(19) United States
(12) Patent Application Publication
(10) Pub. No.: US 2022/0219745 A1
(43) Pub. Date: Jul. 14, 2022

(54) CARRIER DEVICE WITH COUPLING MECHANISM

(71) Applicant: NHK SPRING CO., LTD., Yokohama-shi, (JP)

(72) Inventors: Tsuyoshi AMEMIYA, Yokohama-shi (JP); Yuta SOUDA, Yokohama-shi (JP); Kouichi SHOGAWA, Yokohama-shi (JP); Shimpei KAKIUCHI, Yokohama-shi (JP)

(73) Assignee: NHK SPRING CO., LTD., Yokohama-shi (JP)

(21) Appl. No.: 17/564,245

(22) Filed: Dec. 29, 2021

(30) Foreign Application Priority Data
Jan. 14, 2021 (JP) 2021-004118

(51) Int. Cl. B62B 3/04

(52) U.S. Cl. CPC B62B 3/04; B62B 2202/90

(57) ABSTRACT

A carrier device includes a coupling mechanism for coupling an automatic controlled vehicle to a carriage. The coupling mechanism includes a first shaft member, a second shaft member and a third shaft member. The coupling mechanism includes a guide rail section, a lock member, and an actuator that moves the lock member. The guide rail section is provided on the automatic controlled vehicle. When the lock member moves from the first position to the second position, the lock member enters between the first shaft member and the second shaft member. The third shaft member fits with the fitting portion of the lock member.

### CROSS-REFERENCE TO RELATED APPLICATIONS

This application is based upon and claims the benefit of priority from prior Japanese Patent Application No. 2021-004118, filed Jan. 14, 2021, the entire contents of which are incorporated herein by reference.

### BACKGROUND OF THE INVENTION

### 1. Field of the Invention

The present invention relates to a carrier device comprising a coupling mechanism for coupling, for example, a caster-mounted carriage to an automatic controlled vehicle.

### 2. DESCRIPTION OF THE RELATED ART

In production sites such as factories, warehouses and the like, caster-mounted carriages are used to move objects to be carried. The caster-mounted carriages may be carts or wagons. To move the carriages to desired locations, an automatic controlled vehicle may be used. In this case, each carriage is coupled to the automatic controlled vehicle via a coupling mechanism. The coupling mechanism couples the carriage and the automatic controlled vehicle to each other as needed. The coupling mechanism can also decouple the carriage from the automatic controlled vehicle.

JP 2013-232078 A (Patent Literature 1) describes an automatic controlled vehicle including a coupling mechanism that uses a coupling pin. The automatic controlled vehicle is configured to be able to enter the undersides of carriages. The coupling mechanism includes a coupling pin, a drive mechanism for moving the coupling pin in the vertical direction, and a pin receiving portion. The coupling pin is provided on an upper surface of the automatic controlled vehicle. The pin receiving portion is provided on the lower surface of the carriage. The coupling pin is ascended by the drive mechanism, and then, the coupling pin is inserted to the pin receiving portion. Thus, the carriage is coupled to the automatic controlled vehicle.

JP 2019-162953 A (Patent Literature 2) describes an automatic controlled vehicle including a coupling portion. The coupling portion includes a coupling rod and a clamping mechanism. The coupling rod is provided on the lower surface of the carriage. The clamping mechanism is provided on the upper surface of the automatic controlled vehicle. While the automatic controlled vehicle is inserted underneath the carriage, the coupling rod is grasped with the clamping mechanism. Thus, the carriage is coupled to the automatic controlled vehicle.

JP 201.8-24415 A (Patent Literature 3) describes an automatic controlled vehicle comprising a guide portion and a coupling mechanism. The first example of the coupling mechanism described in Patent Literature 3 includes a pair of guide portions, a coupled member and a coupling pin. The pair of guide portions are provided on the upper surface of the automatic controlled vehicle. The coupled member is provided on the lower surface of the carriage. The coupling pin is movable along the horizontal direction. The coupled member includes a pin receiving hole formed therein to insert the coupling pin thereto. While the coupled member is inserted between the guide portions, the coupling pin is inserted to the pin receiving hole. Thus, the carriage is coupled to the automatic controlled vehicle.

The second example of the coupling mechanism in Patent Literature 3 comprises a pair of guide portions, a pair of coupling shafts and a coupling member. The pair of guide portions are provided on the upper surface of the automatic controlled vehicle. The pair of coupling shafts are provided on the lower surface of the carriage. The coupling member is movable along the horizontal direction. While the coupling shafts are inserted between the guide portions, the coupling member is pressed against the coupling shafts. Thus, the carriage is coupled to the automatic controlled vehicle.

In the coupling mechanism described in Patent Literature 1, the coupling pin is inserted to the pin receiving portion. With this structure, if the relative positions of the automatic controlled vehicle and the carriage are shifted even slightly during coupling, the coupling pin cannot be inserted to the pin receiving portion.

The clamping mechanism described in the above-mentioned patent document 2 can be used even if the positioning accuracy of the automatic controlled vehicle relative to the carriage may be loose. However, when the automatic controlled vehicle and the carriage turned around the vertical axis, excessive load is applied to the clamping mechanism, which undesirably may easily cause damage to the clamping mechanism.

In the first example of Patent Literature 3, the horizontally movable metal-made coupling pin is inserted to the pin receiving hole of the metal-made coupled member. With such a structure, contact noise between the coupling pin and the pin receiving hole and vibration thereof are problematic. Especially in clean rooms where a clean environment is required, the generation of fine particles (micro-particles) by friction between metals creates a major problem. In the second example of Patent Literature 3, the coupling member is pressed against the coupling shaft. In such a structure, it is necessary to keep pressing the coupling member against the coupling rod with a large force. Therefore, a great amount of consumption energy is involved, placing a heavy load on the battery. Further, the rigidities of the coupling member and the coupling shaft need to be considerably increased.

The present invention provides a carrier device comprising a coupling mechanism that has a large coupling strength between the automatic controlled vehicle and the carriage and also can suppress generation of dust such as metal particles.

### BRIEF SUMMARY OF THE INVENTION

According to one embodiment, a carrier device comprises a coupling mechanism that couples an automatic controlled vehicle to a carriage. The coupling mechanism comprises a first shaft member, a second shaft member and a third shaft member. The first shaft member and the second shaft member are disposed on the carriage with an interval therebetween in a horizontal direction. The first shaft member and the second shaft member each extend downward from the carriage. The third shaft member is disposed between the first shaft member and the second shaft member. The third shaft member extends downward from the carriage.

The automatic controlled vehicle comprises a guide rail section, a lock member and an actuator. The guide rail section includes a pair of rail members extending in the horizontal direction. The guide rail section comprises a gap formed between the pair of rail members. In to the gap, the first shaft member and the second shaft member can enter. The lock member is movable between a first position and a second position. The lock member is separated from the third shaft member when moved to the first position. The lock member is fitted with the third shaft member when moved to the second position. The actuator moves the lock member between the first position and the second position.

According to a carrier device comprising a coupling mechanism according to this embodiment, a large coupling strength can be obtained between the automatic controlled vehicle and the carriage, and further the generation of dust can be suppressed.

In the above-provided embodiment, the first shaft member may include a first roller portion, the second shaft member may include a second roller portion, and the third shaft member may include a third roller portion. The first roller portion rotates around a first axis extending along vertical direction. The second roller portion rotates around a second axis extending along the vertical direction. The third roller portion rotates around a third axis extending along the vertical direction.

The first roller portion, the second roller portion and the third roller portion are made of a material having rubber elasticity. The diameter of the first roller portion and the diameter of the second roller portion are equivalent to each other. The diameter of the third roller portion may be less than the diameter of the first roller portion and the diameter of the second roller portion.

The guide rail section comprises straight portions, a first expanding portion and a second expanding portion. The straight portions form longitudinal parts of the pair of rail members and are parallel to each other. In the first expanding portion, the gap expands as a distance from one end of the straight portions increases. In the second expanding portion, the gap expands as a distance from the other end of the straight portion increases.

The lock member may include one side surface and the other side surface along a direction of movement of the lock member. The lock member may include an end portion including a pair of guide surfaces. The distance between the guide surfaces decreases from the respective side surfaces toward the end surface of the lock member. Further, the lock member may include a fitting portion. The fitting portion comprises a recess portion to fit with the third roller portion.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a carrier device according to one embodiment.

FIG. 2 is a perspective view of the carrier device shown in FIG. 1 while an automatic controlled vehicle thereof and a carriage are separated from each other.

FIG. 3 is a front view partially showing the carrier device.

FIG. 4 is a side view partially showing the carrier device.

FIG. 5 is a plan view of the automatic controlled vehicle of the carrier device.

FIG. 6 is a plan view showing the automatic controlled vehicle of the carrier device and a part of the carriage.

FIG. 7 is a plan view showing a state where the carriage is coupled by the lock member to the carrier device.

### DETAILED DESCRIPTION OF THE INVENTION

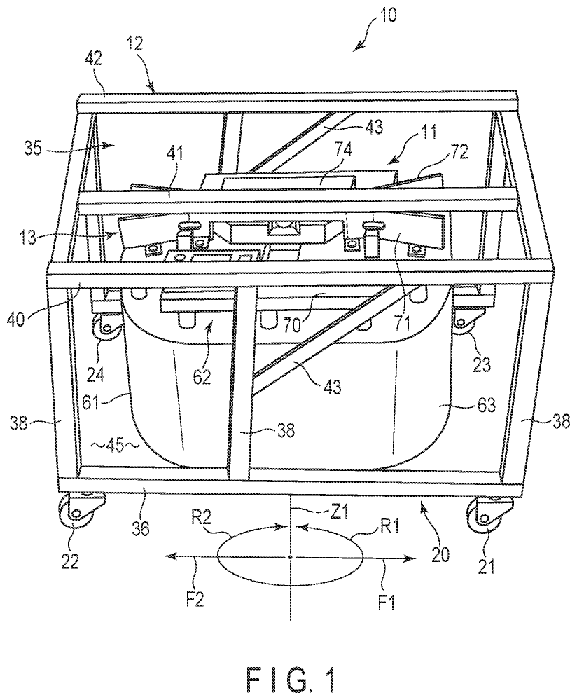

A carrier device according to one embodiment will be described with reference to FIGS. 1 to 7.

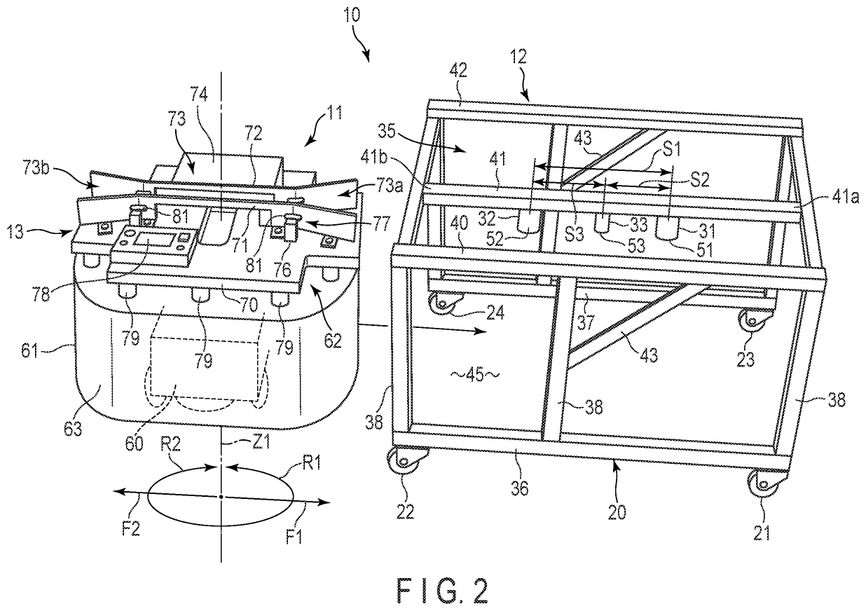

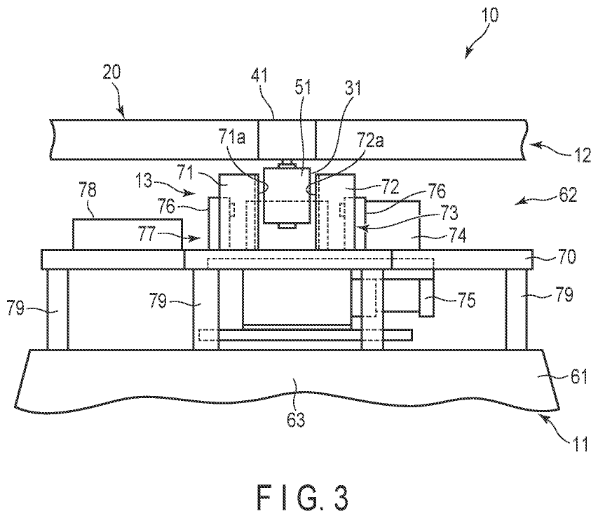

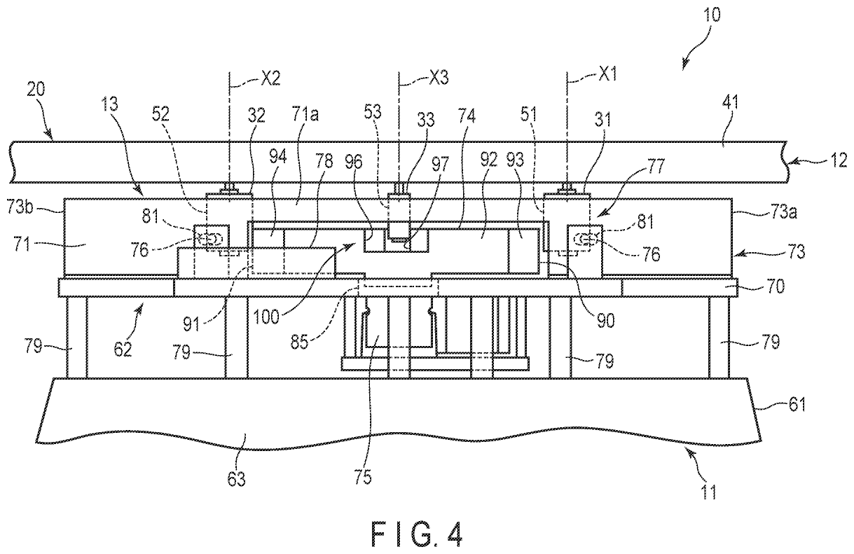

FIG. 1 is a perspective diagram showing a carrier device 10. The carrier device 10 includes an automatic controlled vehicle 11, a carriage 12 and a coupling mechanism 13. The coupling mechanism 13 has the function of coupling the automatic controlled vehicle 11 and the carriage 12 to each other. FIG. 2 shows the state where the automatic controlled vehicle 11 is separated from the carriage 12. FIG. 3 shows a front view of a part of the carrier device 10, and FIG. 4 shows a side view of a part of the carrier device 10.

The automatic controlled vehicle 11 will be explained in detail later, and the carriage 12 will be explained first.

The carriage 12 comprises a frame structure 20, casters 21, 22, 23 and 24, a first shaft member 31, a second shaft member 32 and a third shaft member 33. The shaft members 31, 32 and 33 are provided in the frame structure 20. The shaft members 31, 32 and 33 forms a part of the coupling mechanism 13. In an upper portion of the frame structure 20, a loading section 35 (shown in FIGS. 1 and 2) is formed for loading an object to be carried thereon.

The frame structure 20 includes a pair of lower frames 36 and 37, a vertical frame 38, upper frames 40, 41 and 42, a reinforcing member 43 and the like. The vertical frame 38 extends along the vertical direction. Under the upper frames 40, 41 and 42, a space section 45 is formed. To the space section 45, the automatic controlled vehicle 11 can enter from the horizontal direction.

The casters 21 and 22 are provided on respective ends of the lower frame 36. The casters 23 and 24 are also provided on respective ends of the other lower frame 37. The casters 21, 22, 23 and 24 can each rotate around a vertical axis. The casters 21, 22, 23 and 24 can change their orientations according to the direction of movement of the carriage 12.

The first shaft member 31 is provided at a position of the upper frame 41, which is closer to one longitudinal end 41a thereof. The first shaft member 31 is disposed on the lower surface of the upper frame 41. The first shaft member 31 extends downward from the upper frame 41. The first shaft member 31 includes a first roller portion 51 which is freely rotatable. The first roller portion 51 is made, for example, from a material having rubber elasticity, such as a urethane elastomer. The first roller portion 51 can swivel around a first axial line X1 (shown in FIG. 4) extending along the vertical direction.

The second shaft member 32 is provided at a position of the upper frame 41, which is closer to a longitudinal other end 41b thereof. The second shaft member 32 is disposed on the lower surface of the upper frame 41. The second shaft member 32 extends downwards from the upper frame 41. The second shaft member 32 includes a second roller portion 52 which is freely rotatable.

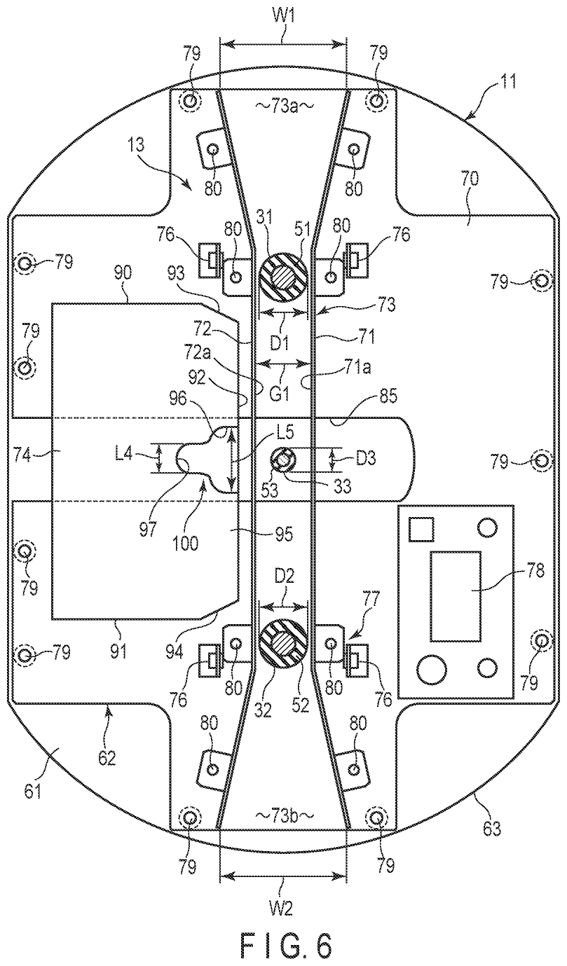

As in the case of the first roller portion 51, the second roller portion 52 is made, for example, from a rubber elastic material such as a urethane elastomer. The second roller portion 52 can swivel around a second axial line X2 (shown in FIG. 4) extending along the vertical direction. A diameter D2 of the second roller portion 52 (shown in FIG. 6) is the same as a diameter D1 of the first roller portion 51.

The third shaft member 33 is provided between the first shaft member 31 and the second shaft member 32. The third shaft member 33 is located approximately at the longitudinal center of the upper frame 41. The third shaft member 33 is disposed on the lower surface of the upper frame 41. The third shaft member 33 extends downwards from the upper frame 41. The third shaft member 33 includes a third roller portion 53 which is freely rotatable.

The third roller portion 53 is made from a material having rubber elasticity, as in the case of the first roller portion 51 and the second roller portion 52. The third roller portion 53 can swivel around a third axial line X3 (shown in FIG. 4) extending along the vertical direction. A diameter D3 (shown in FIG. 6) of the third roller portion 53 is less than the respective diameters D1 and D2 of the first and second roller portions 51 and 52.

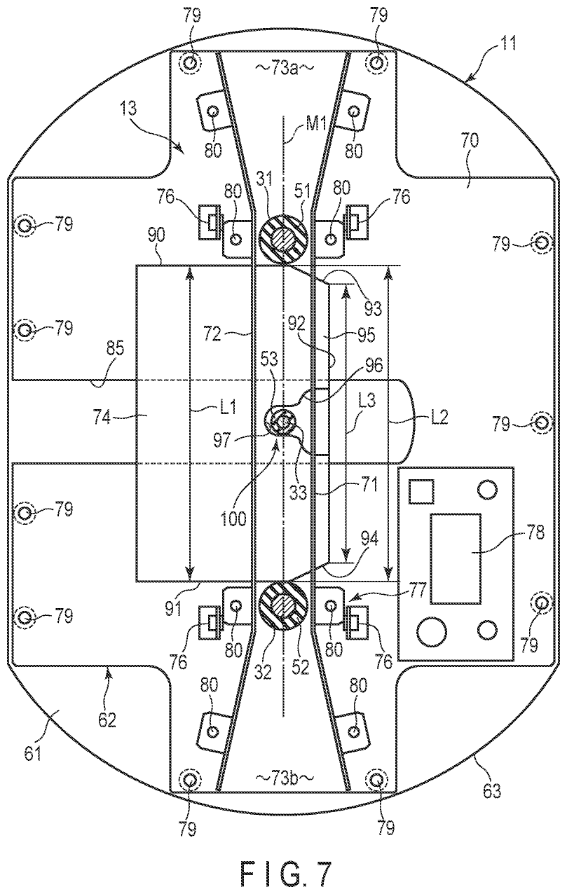

As shown in FIG. 7, the first shaft member 31, the second shaft member 32 and the third shaft member 33 are arranged along a virtual straight line M1 when viewed from above. The virtual straight line M1 extends along the horizontal direction. As shown in FIG. 2, the first shaft member 31 and the second shaft member 32 are disposed on the upper frame 41 with a predetermined distance S1 therebetween with respect to each other along the horizontal direction.

A distance S2 from the first shaft member 31 to the third shaft member 33 is equivalent to a distance S3 from the second shaft member 32 to the third shaft member 33. That is, the first shaft member 31 and the second shaft member 32 are arranged in symmetrical positions with respect to the third shaft member 33 interposed therebetween.

Next, the automatic controlled vehicle 11 will be described.

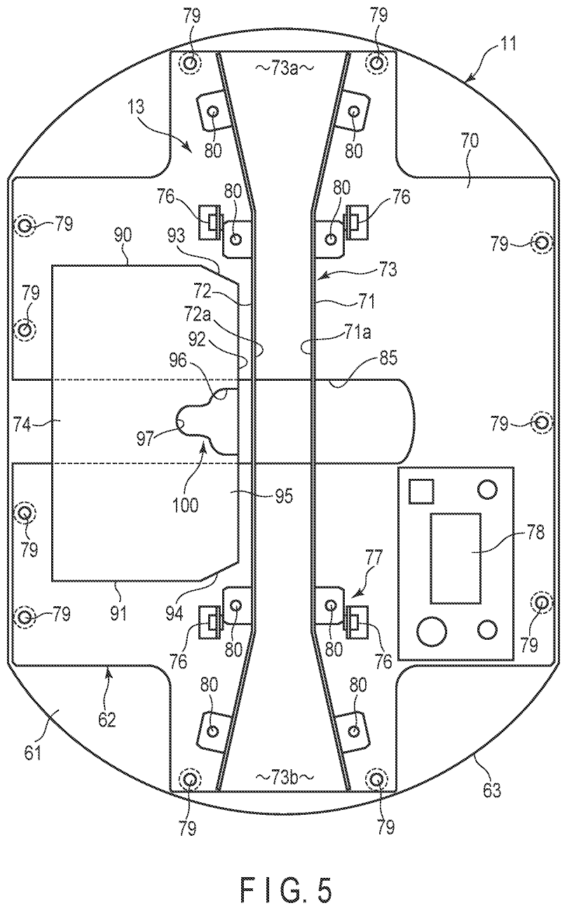

FIG. 5 is a plan view showing the automatic controlled vehicle 11. The automatic controlled vehicle 11 includes a vehicle main body 61 and a coupling unit 62. The vehicle main body 61 includes a traveling mechanism 60 (shown in FIG. 2). The traveling mechanism 60 is covered by a cover member 63. The coupling unit 62 is disposed on top of the vehicle main body 61. The vehicle main body 61 contains software and electrical components for controlling automatic operation. The vehicle main body 61 runs along a predetermined travel path.

The traveling mechanism 60 comprises wheels. The vehicle main body 61 moves in a first direction (indicated by arrow F1) and a second direction (indicated by arrow F2) by the traveling mechanism 60. The traveling mechanism 60 also comprises a steering mechanism. The vehicle main body 61 can be swiveled around the vertical axis Z1 by the steering mechanism. That is, the vehicle main body 61 can swivel in the first rotational direction indicated by the arrow R1 and in the second rotational direction indicated by the arrow R2 in FIG. 2.

The coupling unit 62 is provided on top of the vehicle main body 61. The coupling unit 62 forms a part of the coupling mechanism 13. The coupling unit 62 includes a base plate 70, a guide rail section 73 including a pair of rail members 71 and 72, a lock member 74, an actuator 75 (shown in FIGS. 3 and 4), a detecting section 77 including a plurality of sensors 76, a display section 78 and the like. The base plate 70 expands in substantially horizontal direction. The pair of rail members 71 and 72 are disposed on top of the base plate 70. The lock member 74 is moved along the horizontal direction by the actuator 75. The detecting section 77 has the function of detecting the roller portions 51 and 52. The base plate 70 is fixed to the upper surface of the vehicle main body 61 by a plurality of fixing members 79 such as bolts.

The pair of rail members 71 and 72 are each made of, for example, a metal plate. The rail members 71 and 72 are fixed to the base plate 70 by fixing members 80 (shown in FIGS. 5 to 7). The rail members 71 and 72 includes straight portions 71a and 72a, respectively. The straight portions 71a and 72a are parallel to each other and extend along the horizontal direction. The straight portions 71a and 72a form longitudinal parts of the rail members 71 and 72, respectively.

Between the straight portions 71a and 72a, a gap G1 (shown in FIG. 6) is formed. The gap G1 is slightly greater than the diameter D1 of the first roller 51. The gap G1 is slightly greater than the diameter D2 of the second roller portion 52. For example, the gap G1 is 1 nm to several mm greater than the diameter D1 of the first roller 51. The gap G1 is 1 mm to several mm greater than the diameter D2 of the second roller portion 56. With this structure, the first roller portion 51 and the second roller portion 52 can enter the gap G1.

At one end side of the guide rail section 73, a first expanding portion 73a is formed. At the other end side of the guide rail section 73, a second expanding portion 73b is formed. FIG. 6 is a plan view of the automatic controlled vehicle 11 viewed from above. As viewed from above, the guide rail section 73 incudes the first expanding portion 73a and the second expanding portion 73b. In the first expanding portion 73a, as the distance from one end of the straight portion 71a or 72a increases, the distance (gap G1) between the rail members 71 and 72 increases. An inlet width W1 of the first expanding portion 73a is twice or more the diameter D1 of the first roller portion 51. The inlet width W1 is also twice or more the diameter D2 of the second roller portion 52. With this structure, the first roller portion 51 and the second roller portion 52 can each easily enter between the rail members 71 and 72.

In the second expanding portion 73b, as the distance from the other end of the straight portion 71a or 72a increases, the distance (gap G1) between the rail members 71 and 72 increases. An inlet width W2 of the second expanding portion 73b is twice or more the diameter D1 of the first roller portion 51. The inlet width W2 is also twice or more the diameter D2 of the second roller portion 52. With this structure, the first roller portion 51 and the second roller portion 52 can each easily enter between the rail members 71 and 72.

The detecting section 77 including a plurality of sensors 76 detects the roller portions 51 and 52 when the automatic controlled vehicle 11 enters the space section 45 of the carriage 12. In the rail members 71 and 72, openings 81 (shown in FIG. 4) are formed at positions corresponding to the sensors 76. Light for sensing is detected by the detecting section 77 through the openings 81.

As shown in FIGS. 5 to 7, a groove 85 is formed in the base plate 70. The groove 85 extends in a direction perpendicular to the straight portions 71a and 72a of the rail members 71 and 72. The lock member 74 can move horizontally along the groove 85. The lock member 74 moves over between a first position (a standby position) shown in FIGS. 5 and 6 and a second position (a locked position) shown in FIG. 7. The actuator 75 (shown in FIGS. 3 and 4) is provided on the base plate 70. The actuator 75 moves the lock member 74 to the first position and the second position. For example, the actuator 75 is a ball screw mechanism with a servo motor as the driving source.

As viewing the automatic controlled vehicle 11 from above, the lock member 74 includes one side surface 90, the other side surface 91, an end portion 95 and a fitting portion 100. The one side surface 90 and the other side surface 91 each extend along a direction parallel to the groove 85. The end portion 95 includes an end surface 92 and guide surfaces 93 and 94. The fitting portion 100 includes an opening 96 and a recess portion 97. The side surfaces 90 and 91 each extend along the direction of movement of the lock member 74. The lock member 74 moves between the first position and the second position. The end surface 92 is formed in a front side with respect to the direction of movement of the lock member 74 from the first position to the second position.

In FIG. 7, a distance L1 is measured between one side surface 90 of the lock member 74 and the other side surface 91, a distance L2 is measured between the first roller portion 51 and the second roller portion 52. The end surface 92 has a width L3. Here, L1 is slightly less than L2. For example, L1 is a few millimeters less than L2, and L3 is sufficiently less than L2. That is, the relationship can be expressed as: L2>L1>L3. Between the side surface 90 and the end surface 92, a first guide surface 93 is formed to diagonally extend. Between the other side surface 91 and the end surface 92, a second guide surface 94 is formed to diagonally extend.

The guide surfaces 93 and 94 are formed on the end portion 95 of the lock member 74, and therefore the width of the end portion 95 decreases in a tapered form from the side surfaces 90 and 91 towards the end surface 92. Since the guide surfaces 93 and 94 are formed on the end portion 95, the lock member 74 can enter between the first shaft member 31 and the second shaft member 32 even if the relative positions of the automatic controlled vehicle 11 and the carriage 12 are slightly displaced with respect to each other.

The fitting portion 100 is formed in the end portion 95 of the lock member 74. The fitting portion 100 comprises the opening 96 and the recess portion 97. The opening 96 has such a size as to allow the third roller portion 53 to easily enter. The recess portion 97 has such a size for the third roller portion 53 to fit thereinto. The opening 96 and the recess portion 97 are formed in the center of the end surface 92 along the width direction. As shown in FIG. 6, the recess portion 97 has the width L4. The third roller portion 53 has a diameter D3. The width L4 is slightly greater than the diameter D3.

The opening 96 is open to the end surface 92 of the lock member 74. The width L5 of the opening 96 (shown in FIG. 6) is sufficiently larger than the diameter D3 of the third roller portion 53. As shown in FIG. 6, the lock member 74 is away from the third shaft member 33 when the lock member 74 is moved to the first position.

FIG. 7 illustrates the state where the lock member 74 has been moved from the first position to the second position. When the lock member 74 is moved from the first position to the second position, the third roller portion 53 enters the opening 96, which is wide and then fits into the recess portion 97. At this time, the lock member 74 is positioned between the first roller portion 51 and the second roller portion 52.

Now, the operation of the carrier device 10 of this embodiment will be described.

First, towards the carriage 12, which is stopped, the automatic controlled vehicle 11 moves in a direction approaching the carriage 12. Then, the automatic controlled vehicle 11 enters the space section 45 inside the carriage 12. When the automatic controlled vehicle 11 enters the inside of the carriage 12, the vehicle 11 moves forward toward the gap G1 in the guide rail section 73. According to the moving direction of the automatic controlled vehicle 11, the first roller portion 51 or the second roller portion 52 is guided by the first expanding portion 73a or the second expanding portion 73b. Then, the roller portions 51 and 52 enter the gap G1 of the guide rail section 73.

The gap G1 of the guide rail section 73 is greater than the diameter D1 of the first roller portion 51 and the diameter D2 of the second roller portion 52. With this structure, when the first roller portion 51 and the second roller portion 52 enter the gap G1, the first roller portion 51 and the second roller portion 52 are rotated while touching one of the rail members 71 and 72, respectively. Thus, the roller portions 51 and 52 are rotated, it is possible to avoid generation of dust, which may be caused by the first roller portion 51 and the second roller portion 52 rubbing against the guide rail section 73.

FIG. 6 illustrates the state where the automatic controlled vehicle 11 has been moved to a predetermined position (the coupling position) with respect to the roller portions 51 and 52 of the carriage 12. At this time, the lock member 74 is located at the first position (the standby position). When the automatic controlled vehicle 11 is moved to a predetermined position with respect to the carriage 12, the roller portions 51 and 52 are detected by the sensors 76, and the automatic controlled vehicle 11 is stopped. At this time, the roller portions 51 and 52 are located in the gap G1 of the guide rail section 73.

FIG. 7 illustrates the state where the lock member 74 has been moved to the second position (the lock position). The lock member 74 is moved from the first position to the second position by the actuator 75 (shown in FIGS. 3 and 4). When the lock member 74 is moved to the second position, the relative positions of the automatic controlled vehicle 11 and the carriage 12 may be displaced with respect to each other along the length direction of the guide rail section 73. In that case, the first roller portion 51 or the second roller portion 52 is brought into contact with the first guide surface 93 or the second guide surface 94.

While the first roller portion 51 or the second roller portion 52 in contact with the first guide surface 93 or the second guide surface 94, the lock member 74 moves toward the second position. Accordingly, the first roller portion 51 or the second roller portion 52 is rotated. In this manner, it is possible to avoid generation of particles (dust), which may occur when the lock member 74 moves to the second position.

When the lock member 74 reaches the second position as shown in FIG. 7, the third roller portion 53 passes through the opening 96 of the fitting portion 100 and enters the recess portion 97. Here, the width L4 of the recess portion 97 (shown in FIG. 6) is slightly greater than the diameter D3 of the third roller portion 53. When the third roller portion 53 is brought into contact with the inner surface of the recess 97, the third roller portion 53 is rotated. In this manner, it is possible to avoid dust generation when the third roller portion 53 enters the recess 97, which may occur between these members rubbing against each other.

In a state where the third roller portion 53 enters the recess 97 of the fitting portion 100, the automatic controlled vehicle 11 runs. For example, the automatic controlled vehicle 11 moves in the first direction F1 (shown in FIG. 1) or the second direction F2. Here, the third roller portion 53 is fit with the recess portion 97, and therefore to the automatic controlled vehicle 11 and the carriage 12 can be securely coupled to each other against the load applied to the coupling mechanism 13 when running.

The first roller portion 51 and the second roller portion 52 are located in the gap G1 of the guide rail section 73. Therefore, the guide rail section 73 inhibits the automatic controlled vehicle 11 and the carriage 12 from moving in the width direction with relative to each other. When the automatic controlled vehicle 11 and the carriage 12 swivel around the vertical axis Z1, a load (torque) in the rotational direction is applied to the coupling mechanism 13. Against such a load in the rotational direction, the coupling mechanism 13 can exhibit a great deal of strength.

While the automatic controlled vehicle 11 and the carriage 12 are coupled to each other, the automatic controlled vehicle 11 automatically runs along a predetermined route. As a result, the object to be carried on the carriage 12 are carried to the predetermined location. The automatic controlled vehicle 11 and the carriage 12 may swivel around the vertical axis Z1 to change direction. When the automatic controlled vehicle 11 swivel around the vertical axis Z1, the casters 21, 22, 23 and 24 are turned and rotated. Therefore, a large force is applied to the coupling mechanism 13.

Against swiveling around the vertical axis Z1, the first roller portion 51 and the second roller portion 52 are constrained by the guide rail section 73. Further, the third roller portion 53 is fixed by the fitting portion 100 of the lock member 74. With this structure, the coupling mechanism 13 can exhibit a great deal of strength against the load created when the automatic controlled vehicle 11 and the carriage 12 move relative to each other in back and forth direction or swivel around the vertical axis Z1.

When implementing the present invention, it is only natural to carry out by remodeling specific embodiments thereof in various ways, for the specific structures of the automatic controlled vehicle and the carriage, as well as, for example, the first to third shaft members, roller portions, guide rail sections, lock members, actuators, etc., which constitute the coupling mechanism.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A carrier device comprising a coupling mechanism that couples an automatic controlled vehicle to a carriage,
the coupling mechanism comprising:
a first shaft member and a second shaft member, disposed on the carriage with an interval therebetween in a horizontal direction and extending downward from the carriage;
a third shaft member disposed between the first shaft member and the second shaft member and extending downward from the carriage;
a guide rail section disposed in the automatic controlled vehicle and including a pair of rail members extending in the horizontal direction and comprising a gap between the pair of rail members, between which the first shaft member and the second shaft member enter;
a lock member provided on the automatic controlled vehicle so as to be movable between a first position and a second position, which is separated from the third shaft member when moved to the first position, and fitted with the third shaft member when moved to the second position; and
an actuator which moves the lock member between the first position and the second position.

2. The carrier device of claim 1, wherein
the first shaft member includes a first roller portion that rotates around a first axis extending along vertical direction,
the second shaft member includes a second roller portion that rotates around a second axis extending along the vertical direction, and
the third shaft member includes a third roller portion that rotates around a third axis extending along the vertical direction.

3. The carrier device of claim 2, wherein
the first roller portion, the second roller portion and the third roller portion are each made of a material having rubber elasticity, and
a diameter of the first roller portion and a diameter of the second roller portion are equivalent to each other, and a diameter of the third roller portion is less than the diameter of the first roller portion and the diameter of the second roller portion.

4. The carrier device of claim 1, wherein
the guide rail section comprises:
straight portions that form longitudinal parts of the pair of rail members and are parallel to each other;
a first expanding portion in which the gap expands as a distance from one end of the straight portions increases; and
a second expanding portion in which the gap expands as a distance from an other end of the straight portion increases.

5. The carrier device of claim 2, wherein
the lock member includes:
one side surface and an other side surface along a direction of movement of the lock member; and
an end portion including a pair of guide surfaces, a distance between which decreases from the respective side surfaces toward the end surface of the lock member.

6. The carrier device of claim 2, wherein
the lock member includes a fitting portion comprising a recess portion fitting with the third roller portion.
